(19) United States
(12) Patent Application Publication
(10) Pub. No.: US 2003/0159052 A1
(43) Pub. Date: Aug. 21, 2003

(54) Security system and security inspection method using physical information stored in storage medium

(76) Inventors: Kyung Yul Lee, Puchon-shi (KR); Hyun Do Nam, Sungnam-shi (KR); Bong Yul Lee, Kunpo-shi (KR)

Correspondence Address: JORDAN AND HAMBURG LLP, 122 EAST 42ND STREET, SUITE 4000, NEW YORK, NY, 10168, US

(21) Appl. No.: 10/297,159

(22) PCT Filed: May 31, 2001
(86) PCT No.: PCT/KR01/00915

(30) Foreign Application Priority Data
Jun. 1, 2000 (KR) 2000/30061

(51) Int. Cl. H04K 1/00; H04L 9/00

(52) U.S. Cl. 713/186

(57) ABSTRACT

The present invention is to an identification system and method that is accomplished comparison and determination of biometric information stored in storage medium and detected from person on site in the identification system such that the present invention enable to reduce time and cost that it takes to communicate biometric information in communication network. Furthermore, after comparing and determining the biometric information, the present invention completely deletes the register data and the biometric information data of the person remained in the temporary memory means such that the present invention is to an identification system and method enabling to prevent the information from leakage and hacking. The present invention provides an identification system using biometric information registered in storage medium and detected from the person on site, wherein the identification system comprising: a storage medium reader for reading a data from the portable storage medium and extracting information on a type of the storage medium and stored data format and biometric information stored therein; a biometric information collector for obtaining biometric information from a person on site; an analyzer for comparing the registered biometric information in the storage medium with biometric information from the biometric information collector, determining whether or not the biometric information from the storage medium reader and biometric information collector are identical to each other, and generating verification result.

### TECHNICAL FIELD

This invention relates to an identification system and method, and more particularly, to an identification system and method for identifying an authorized person using biometric information stored in a potable storage medium and biometric information detected from a person on site.

### BACKGROUND ART

Currently, an identification system using biometric information has been developed so as to give access only authorized person. Among the biometric information fingerprint is widely used.

In the conventional identification system, however, the biometric information is processed in a host computer (Central Processing Unit (CPU)) of the identification system or other separate authentication sever such that the information can be stolen for illegal usage and be easily exposed to hacking on communication.

Furthermore, in the conventional identification system, the registered biometric information is temporarily resided on the memory devices of terminal even after being used on site such that this temporarily resided information can be duplicated or stolen for illegal usage.

In case of deposit withdrawal using a cash card or a credit card in ATM (Automated Teller Machines), fraudulent using of other person's ID number is so frequently occurred.

### DISCLOSURE OF INVENTION

The present invention has been made in an effort to solve the above problems of the prior art.

An object of the present invention is to provide an identification system and method capable of identifying a person as an authorized one by comparing biometric information stored in a portable storage medium presented by a person with biometric information obtained from a part of the person on site.

In order to achieve the above object, the identification system according to one aspect of the present invention comprises: a storage medium reader for reading a data from a potable storage medium and extracting information on a type of the storage medium and stored data format and biometric information registered therein; a biometric information collector for obtaining biometric information of the person on site; an analyzer for comparing the registered biometric information in the storage medium with the biometric information detected from the biometric information collector, determining whether or not the biometric information from the storage medium reader and biometric information collector are identical to each other, and generating verification result.

In order to achieve the above object, an identification method according to an aspect of the present invention comprises the steps of reading biometric information registered in a potable storage medium with a storage medium reader, collecting biometric information from the person with a biometric information collector and temporarily storing the biometric information, and comparing the registered biometric information in the storage medium with biometric information detected from the biometric information collector, determining whether or not the biometric information from the storage medium reader and biometric information collector are identical to each other, and generating verification result.

### BRIEF DESCRIPTION OF THE DRAWINGS

The above object and other features of the present invention will become more apparent by describing the preferred embodiments thereof with reference to the accompanying drawings, in which:

FIG. 1 is a block diagram illustrating an identification system using biometric information stored in a potable storage medium and detected from a person on site according to the present invention.

FIG. 2 is a flowchart illustrating an identification process according to the present invention.

### BEST MODE FOR CARRYING OUT THE INVENTION

A preferred embodiment of the present invention will be described hereinafter with reference to the accompanying drawings.

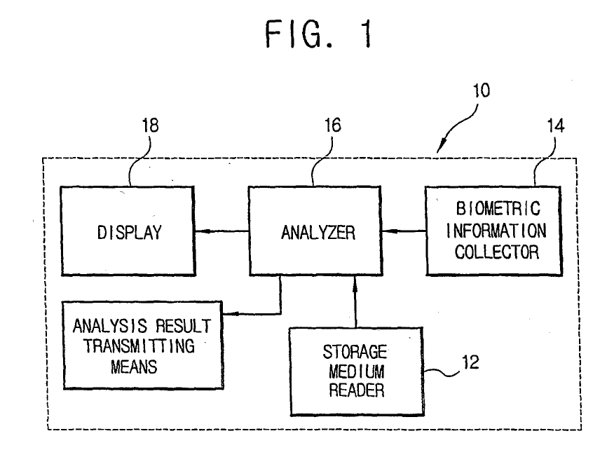

FIG. 1 is a block diagram of an identification system using biometric information stored in a potable storage medium and detected from a person on site according to the present invention.

Referring to FIG. 1, the identification system 10 comprises a storage medium reader 12, a biometric information collector 14, and an analyzer 16. The storage medium reader 12 reads the portable storage medium so as to extract biometric information previously stored therein. The biometric information collector 14 scans a part of the person so as to detect the biometric information therefrom. And the analyzer 16 compares the biometric information from the biometric information collector 14 with the registered biometric information in the storage medium reader 12 so as to determine whether both the biometric information are identical to each other.

The storage medium reader 12 can extract biometric information of the person from the storage medium when the storage medium is presented to the storage medium reader 12.

The storage medium, as a potable storage medium, can be classified into a credit card, debit card, or etc. according to a settlement method, and classified into contact (IC card, magnetic card) or non-contact (RF card) card according to a method of accessing communication medium. Of course, the person's biometric information must be previously stored in his/her card by an authorization institute.

If the storage medium is required to authorize in order to determine whether the storage medium is adequate and valid, the identification system can communicate with a bank, credit card company, or related business as an authorization institute in order to determine whether the storage medium is adequate and valid. In this case the identification system must be connected to the bank, credit card company, or related business through a communication network. For example, the authorization-requiring storage medium can be a bank-issued card such as a credit card, debit card, and etc.

During the communication with the bank or credit card company, the analyzer 16 compares the biometric information stored in the storage medium with the biometric information obtained from the person on site.

The biometric information is encoded before being stored in the storage medium in order to enhance information security.

The encoded biometric information in the storage medium is decoded so as to be read and compared with the biometric information obtained from the person in the analyzer 16.

During the encoding and decoding processes, DES algorithm can be used in the present invention. The DES algorithm is a standard algorithm adopted by National Bureau of Standards (NBS, changed to NIST (National Institute of Standards and Technology) later) in 1977 and widely used in the financial field. Though Tuchman of IBM originally proposed this algorithm, this algorithm went public as a freeware.

The biometric information collector 14 can detect the biometric information such as a fingerprint, iris, voiceprint, and etc. of the person with a sensor, which can distinguish people each other, and one of factors or mixture of two or more factors can be used as the biometric information.

The biometric information collector 14 comprises a fingerprint recognizing means, iris recognizing means, and voiceprint recognizing means.

The analyzer 16 receives the registered biometric information in the storage medium and the biometric information of the person scanned by the biometric information collector 14 and compares with each other.

The analyzer 16 further comprises temporary memory means having memory blocks A and B such that the registered biometric information in the storage medium is stored in Block A and the biometric information obtained from the person is stored in block B.

The analyzer 16 compares the biometric information stored in the Block A with the biometric information stored in Block B, determines whether or not the information is identical to each other, and generates verification result. Right after the comparison, the analyzer 16 overwrites in all the memory addresses from 0 to n of the Block A and Block B by ‘0’ or ‘FF’ so as to delete the information stored in the temporary memory means.

The analyzer 16 repeats the information-deleting step in order for the authorization related data and biometric information not to be remained in the temporary memory means.

Additionally, the identification system 10 further comprises a display 18 for displaying the verification result from the analyzer 16. Also, the verification result can be outputted by sound.

For example, if the biometric information stored in the storage medium is not identical to the biometric information of the person, the display 18 outputs a warning sound or a warning phrase such as ‘Fingerprint is not identical’.

Also, the display 18 shows the person that the register data and biometric information are deleted in the temporary memory means.

The identification system 10 further comprises input means for receiving person instruction such that the person can input commands such as ‘cancel,’ ‘retry,’ or etc. through the input means in order for the system to execute the command.

The identification system 10 further comprises a verification result transmitting means 19 for transmitting information such as the person data, access request counts of the person to the Central Processing Unit (CPU) connected with the identification system 10.

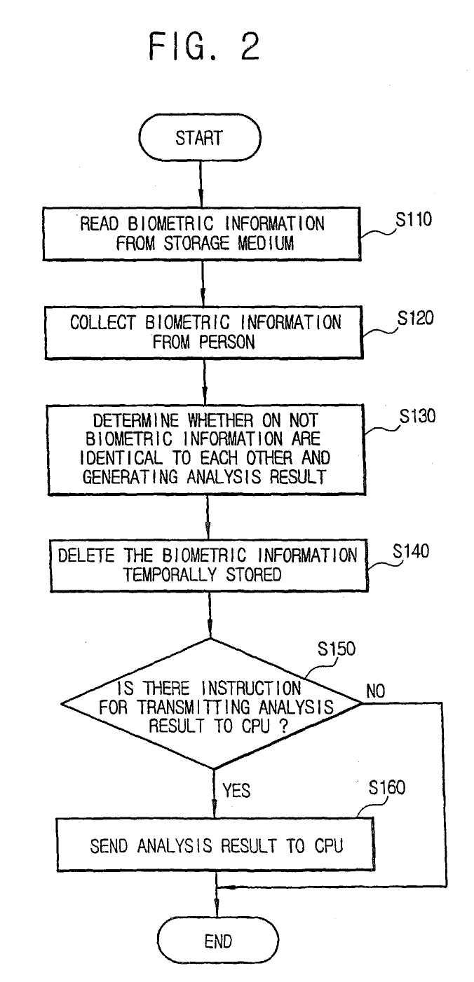

FIG. 2 is a flowchart illustrating an identification process according to the present invention.

Referring to FIG. 2, the method of the present invention will be described hereinafter.

Once the storage medium and the part of the person is presented to the identification system, the identification system reads biometric information stored in the storage medium through the storage medium reader 12 and biometric information from the part of the person through the biometric information collector 14 at steps S110˜S120. Next, the identification system determines whether or not the biometric information from the storage medium reader 12 and the biometric information collector 14 are identical to each other with the analyzer 16, and generates verification result at step S130, and then deletes the used biometric information right after the determination at step S140.

While reading the biometric information, the step S110 and step S120 can be executed in reversed order.

Then, the analyzer 16 of the identification system 10 compares the biometric information detected from the biometric information collector 14 with the registered biometric information in the storage medium, determines whether or not the biometric information from the biometric information collector 14 is identical to the registered biometric information in the storage medium, and generates the verification result at step S130, and then immediately deletes biometric information in the temporary memory means at step S140. The deletion can be repeated in several times for completely clear the temporary memory means.

After deleting the information, if an instruction for transmitting the verification result to the CPU connected with the identification system 10 is inputted, the verification result transmitting means 19 transmits the verification result to the CPU at steps S150˜160.

In FIG. 2, though one kind of biometric information is used for identifying a person, two or more kinds of biometric information such as fingerprint, iris, voiceprint, and etc. can be used for accurate identification.

The present invention is not limited by the above described embodiment, and it should be obvious to people skilled in the art that modifications and alterations could be made to the above embodiments without departing from the scope or spirit of the present invention.

As described above, in the present invention, both of the biometric information comparison and analysis are accomplished in the identification system such that the time and cost for transmit biometric information to the CPU through communication network can be reduced. Furthermore, after comparing and analyzing the biometric information, the register data and the biometric information remained in the temporary memory means are deleted right after the analysis such that it is prevented that the temporal information is duplicated for illegal usage.

1. (Amended) An identification system using biometric information registered in a potable storage medium and biometric information detected from the person, wherein the identification system comprising:
a storage medium reader for reading a data from the potable storage medium and extracting information on a type of the storage medium and stored data format and biometric information stored therein;
a biometric information collector for obtaining biometric information from a person on site; and
an analyzer including a temporary memory having first memory block for storing the biometric information from the storage medium reader, and second memory block for storing the biometric information obtained from the biometric information collector, the analyzer compares the biometric information from the storage medium with biometric information from the biometric information collector, determining whether or not the biometric information from the storage medium reader and biometric information collector are identical to each other, generates the verification result, and deletes the information stored in the first and second memories.

2. The identification system of claim 1 further comprises a communication means for communicating with authentication institute if the storage medium is needed to authenticate by the authentication institute.

3. The identification system of claim 1 further comprises a display for displaying the verification result from the analyzer.

4. The identification system of claim 3 wherein the analyzer deletes the biometric information right after sending the verification result to the display.

5. The identification system of any one of claim 1 to claim 4, wherein the biometric information collector is fingerprint recognizing means such that the analyzer compares the biometric information from the storage medium reader with fingerprint of the person from the fingerprint recognizing means and determines whether or not the biometric information from the storage medium reader and the fingerprint recognizing means are identical to each other.

6. The identification system of any one of claim 1 to claim 4,wherein the biometric information collector is iris recognizing means such that the analyzer compares the biometric information from the storage medium reader with iris of the person from the iris recognizing means and determines whether or not the biometric information from the storage medium reader and the iris recognizing means are identical to each other.

7. The identification system of any one of claim 1 to claim 4, wherein the biometric information collector is voiceprint recognizing means such that the analyzer compares the biometric information from the storage medium reader with voiceprint of the person from the voiceprint recognizing means and determines whether or not the biometric information from the storage medium reader and the voiceprint recognizing means are identical to each other.

8. The identification system of any one of claim 1 to claim 4, wherein the biometric information collector comprises fingerprint recognizing means, iris recognizing means, and/or voiceprint recognizing means for respectively reading a fingerprint, iris and/or voiceprint of the person.

9. The identification system of claim 8, wherein the analyzer compares a fingerprint, iris, and/or voiceprint pattern detected by the fingerprint, iris, and/or voiceprint recognizing means with corresponding biometric information from the storage medium reader and then determines whether or not those biometric information from the biometric information collector and the storage medium reader are identical to each other.

10. (Amended) An identification method using biometric information stored in storage medium, wherein the method comprising the steps of:
(a) reading biometric information registered in a portable storage medium with a storage medium reader;
(b) collecting biometric information from a person with a biometric information collector and temporarily storing the biometric information; and
(c) comparing the registered biometric information in the storage medium with biometric information detected from the biometric information collector, determining whether or not the biometric information from the storage medium reader and biometric information collector are identical to each other, generating verification result, and deleting the biometric information temporarily stored.

11. The identification method of claim 10 further comprises the step of (d) displaying the verification result generated in the step (c).

12. (Delete)
